(19) United States
(12) Patent Application Publication
(10) Pub. No.: US 2012/0279391 A1
(43) Pub. Date: Nov. 8, 2012

(54) ADSORPTION PROCESS TO RECOVER CARBON DIOXIDE FROM FLUE GAS

(76) Inventors: Ravi Kumar, Williamsville, NY (US); Andrew C. Rosinski, Orchard Park, NY (US)

(21) Appl. No.: 13/099,743

(22) Filed: May 3, 2011

(51) Int. Cl. B01D 53/047

(52) U.S. Cl. 95/26

(57) ABSTRACT

A vacuum pressure swing adsorption (VPSA) processes and apparatus recover carbon dioxide having a purity of approximately ≧80 mole percent from streams containing at least carbon dioxide and nitrogen, and essentially no hydrogen (e.g. flue gas). The feed to the CO₂ VPSA is at superatmospheric pressure. The CO₂ VPSA unit produces a CO₂ product stream, and preferably a high-pressure effluent stream that can be expanded to provide power for compressing the feed stream. The recovered CO₂ can be further upgraded, sequestered or used in applications such as enhanced oil recovery.

### FIELD OF THE INVENTION

The present invention generally relates to vacuum pressure swing adsorption (VPSA) processes and apparatus to recover carbon dioxide having a purity of approximately ≧80 mole percent from streams containing at least carbon dioxide and nitrogen, such as the gaseous products of combustion (i.e. flue gas). The feed to the CO₂ VPSA can be at superambient pressure. The CO₂ VPSA unit produces a CO₂ product stream. The process cycle generates a high-pressure product stream that can be used to generate power for compressing the feed stream. The recovered CO₂ can be further upgraded, sequestered or used in applications such as enhanced oil recovery (EOR).

### BACKGROUND OF THE INVENTION

Many industrial operations employ combustion of fuel. Examples include kilns, incinerators, glassmaking furnaces, coal-fired power plants, and the like. Combustion of fuel produces streams of gaseous combustion products that comprise at least carbon dioxide, usually accompanied by nitrogen and one or more of oxygen, oxides of nitrogen and/or sulfur, and carbon monoxide.

It would be desirable to provide economically beneficial processes and apparatus for CO₂ recovery. It would further be desirable for such processes and apparatus to be more efficient and easier to use relative to the prior art.

### SUMMARY OF THE INVENTION

One embodiment of the present invention is a vacuum pressure swing adsorption (VPSA) process for the recovery of carbon dioxide from a multi-component gas mixture which contains at least carbon dioxide and nitrogen and contains no hydrogen or no more than a trace amount of hydrogen, and which is at a pressure in a first superatmospheric pressure range, in a VPSA unit containing at least one adsorption bed containing at least one CO₂-selective adsorbent, the process comprising:

feeding said multi-component gas mixture to the at least one adsorption bed at a first pressure within said first superatmospheric pressure range for a predetermined time to adsorb carbon dioxide onto said adsorbent;

depressurizing the at least one adsorption bed in a first depressurization step from the first pressure to a second pressure that is lower than said first pressure and is within a second pressure range, in a same direction as or an opposite direction to the feed flow;

depressurizing the at least one adsorption bed in a second depressurization step from the second pressure to a third pressure that is lower than said second pressure and is within a third pressure range, in a same direction as or an opposite direction to the feed flow;

depressurizing the at least one adsorption bed in a third depressurization step from the third pressure to a fourth pressure that is lower than said third pressure and is within a fourth pressure range, in a same direction as or an opposite direction to the feed flow;

depressurizing the at least one adsorption bed in a final depressurization step from the fourth pressure to a pressure that is within a range close to ambient in a same direction as the feed flow or in a direction opposite to the feed flow to produce at least a first portion of CO₂ product;

evacuating the at least one adsorption bed from the pressure that is within a range close to ambient to a pressure below ambient in a same direction as the feed flow or in a direction opposite to the feed flow to produce at least a second portion of CO₂ product;

pressure equalizing the at least one adsorption bed in a first pressure equalization step in a same direction as the feed flow or in a direction opposite to the feed flow;

further pressure equalizing the at least one adsorption bed in a second pressure equalization step in a same direction as the feed flow or in a direction opposite to the feed flow;

further pressure equalizing the at least one adsorption bed in a third pressure equalization step in a same direction as the feed flow or in a direction opposite to the feed flow; and

repressurizing the at least one adsorption bed in a repressurization step to a pressure in the first pressure range;

wherein the process is repeated cyclically.

Another embodiment of the present invention is a vacuum pressure swing adsorption (VPSA) process for the recovery of carbon dioxide from a multi-component gas mixture which contains at least carbon dioxide and nitrogen and contains no hydrogen or no more than a trace amount of hydrogen, and which is at a pressure in a first superatmospheric pressure range, in a VPSA unit containing at least one adsorption bed containing at least one CO₂-selective adsorbent, the process comprising:

feeding said multi-component gas mixture to the at least one adsorption bed at a first pressure within said first superatmospheric pressure range for a predetermined time to adsorb carbon dioxide onto said adsorbent;

venting the at least one adsorption bed in a first depressurization step from the first pressure to a second pressure that is lower than said first pressure and is within a second pressure range, in a same direction as or an opposite direction to the feed flow, to produce a vent stream that can be released into the atmosphere;

depressurizing the at least one adsorption bed in a final depressurization step from the second pressure to a pressure that is within a range close to ambient in a same direction as the feed flow or in a direction opposite to the feed flow to produce at least a first portion of CO₂ product;

evacuating the at least one adsorption bed from the pressure that is within a range close to ambient to a pressure below ambient in a same direction as the feed flow or in a direction opposite to the feed flow to produce at least a second portion of CO₂ product; and

repressurizing the at least one adsorption bed in a repressurization step to a pressure in the first pressure range;

wherein the process is repeated cyclically.

Yet another embodiment of the present invention is a vacuum pressure swing adsorption (VPSA) process for the recovery of carbon dioxide from a multi-component gas mixture which contains at least carbon dioxide and nitrogen and contains no hydrogen or no more than a trace amount of hydrogen, and which is at a pressure in a first superatmospheric pressure range, in a VPSA unit containing at least one adsorption bed containing at least one CO₂-selective adsorbent, the process comprising:

feeding said multi-component gas mixture to the at least one adsorption bed at a first pressure within said first superatmospheric pressure range for a predetermined time to adsorb carbon dioxide onto said adsorbent;

depressurizing the at least one adsorption bed from the first pressure to a pressure that is within a range close to ambient in a same direction as the feed flow or in a direction opposite to the feed flow to produce a vent stream that can be released into the atmosphere;

evacuating the at least one adsorption bed from the pressure that is within a range close to ambient to a pressure below ambient in a same direction as the feed flow or in a direction opposite to the feed flow to produce a CO₂ product; and

repressurizing the at least one adsorption bed in a repressurization step to a pressure in the first pressure range;

wherein the process is repeated cyclically.

In preferred embodiments, carbon dioxide is recovered by compressing a multi-component gas mixture which contains at least carbon dioxide and nitrogen and contains no more than a trace amount of hydrogen, to a pressure in a first superatmospheric pressure range, and recovering carbon dioxide from said compressed mixture in a VPSA unit by any of the processes described herein, wherein an effluent gas stream is recovered from said VPSA unit and is expanded to provide power that is used in compressing said multi-component gas mixture.

The present invention generally relates to vacuum pressure swing adsorption (VPSA) processes and apparatus to recover carbon dioxide having a purity of approximately ≧80 mole percent from streams containing at least carbon dioxide and nitrogen, and little or no hydrogen. The feed to the CO₂ VPSA is at superatmospheric pressure (i.e. pressure higher than atmospheric). The CO₂ VPSA unit produces a CO₂ product stream, as well as one or more other streams that can be used as described herein, such as to provide power that can be used to compress the feed to the VPSA unit.

CO₂ produced in accordance with the present invention may be used for any desired purpose. For example and while not to be construed as limiting, CO₂ produced as described herein can be further purified and used in food-grade quality product(s), or can be used for enhanced oil recovery or other industrial processes, or can simply be sequestered to avoid addition of greenhouse gases to the atmosphere.

The present invention utilizes depressurizations of an adsorbent from high pressure to low pressure to increase CO₂ concentration in the bed(s). After CO₂ concentration is increased, CO₂ product is produced by further pressure reduction. This can be accomplished because of the recognition that for some adsorbents, depressurization from high to low pressure increases CO₂ concentration in the adsorbent bed(s).

Consequently, the need for rinse, purge and/or recycle steps as used in the prior art can be eliminated. This in turn allows for the elimination of certain pieces of rotating machines (e.g., rinse compressor, purge compressor, recycle compressor) and associated power requirements, thereby providing a process and apparatus which is simpler to operate and more economical than prior art systems. The proposed processes do not require steam and thus are expected to reduce the cost of CO₂ separation.

To increase CO₂ recovery, a preferred embodiment of the present invention uses the depressurized gas to build up or increase the pressure in lower-pressure beds. The bed depressurization therefore increases CO₂ concentration in the product and by equalizing with other beds in the unit, at the same time, increases CO₂ recovery.

By eliminating the hardware (i.e. rotating machinery) as mentioned hereinabove, and corresponding power requirements, the present invention is expected to more efficiently produce CO₂ from flue gas and other streams containing at least carbon dioxide and nitrogen, relative to the prior art.

### BRIEF DESCRIPTION OF THE DRAWINGS

For a more complete understanding of the present invention and the advantages thereof, reference should be made to the following Detailed Description taken in conjunction with the accompanying drawings in which:

FIG. 1 illustrates embodiments of the present invention in which a CO₂ VPSA unit in accordance with the present invention is incorporated with a unit that uses a high-pressure gas stream from the VPSA unit to generate power used to compress a feed stream to the VPSA unit.

FIG. 2 illustrates a cycle step chart for a CO₂ VPSA unit in accordance with the present invention having six beds and three pressure equalization steps.

FIG. 3 shows a schematic drawing for the CO₂ VPSA unit of FIG. 2.

FIG. 4 shows the valve sequence for operation of the CO₂ VPSA unit shown in FIGS. 2 and 3.

FIGS. 5A and 5B illustrate cycle step charts for additional embodiments of a CO₂ VPSA unit in accordance with the present invention, having four beds.

FIG. 6 shows a schematic drawing for the CO₂ VPSA unit useful in the embodiments of FIGS. 5A and 5B.

FIGS. 7A and 7B show valve sequences for operation of a CO₂ VPSA unit shown in FIG. 6 to practice the embodiments shown in FIGS. 5A and 5B.

FIG. 8 illustrates a cycle step chart for another embodiment of a CO₂ VPSA unit in accordance with the present invention, having three beds.

FIG. 9 shows a schematic drawing for the CO₂ VPSA unit of FIG. 8.

FIG. 10 shows the valve sequence for operation of the CO₂ VPSA unit shown in FIGS. 8 and 9.

### DETAILED DESCRIPTION

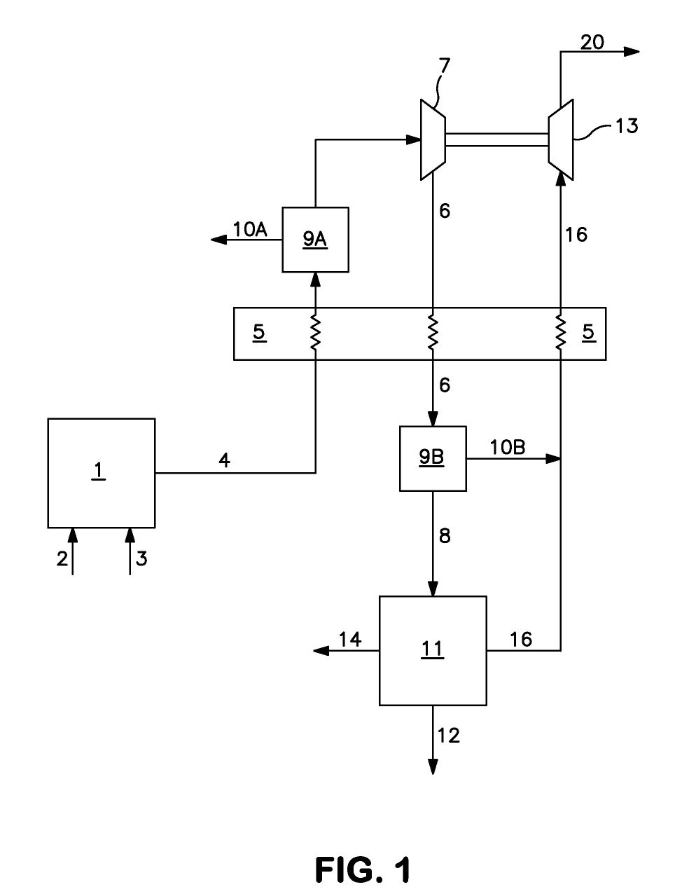

In a preferred embodiment of the present invention and as illustrated in FIG. 1, stream 4 containing at least carbon dioxide and nitrogen is obtained from combustion unit 1. Examples of combustion unit 1 include kilns (such as are employed in manufacture of lime or cement), coal-fired boilers in power plants, glassmelting furnaces, and incinerators. Stream 4 is produced by combustion of carbonaceous fuel 2 (such as oil, coal, natural gas, and the like) in combustion unit 1 with oxidant 3 which can be air, oxygen-enriched air having an oxygen content higher than that of air, streams of oxygen having an oxygen of 90 vol. % or higher, or even streams containing oxygen but at a content less than that of air.

Stream 4 is cooled in heat exchanger 5, from its elevated temperature imparted by the combustion, to a temperature on the order of 30-70 C. Stream 4 is then compressed, as represented by compressor 7, to a pressure in the range of 100-500 psia. The resulting high-pressure stream 6 is cooled, preferably in heat exchanger 5, to a temperature on the order of 30-70 C.

The stream formed in combustion unit 1 typically contains impurities that should be removed from the stream before the stream is processed by the VPSA process of the present invention. Impurities typically include one or more of oxides of sulfur, oxides of nitrogen, and/or water vapor. Impurities that are present may be removed before or after compression in unit 7. For instance, oxides of sulfur are preferably removed by scrubbing with an aqueous solution of soda ash, upstream of compressor 7. Oxides of nitrogen are preferably removed by scrubbing with an aqueous solution of alkali permanganate, downstream of compressor 7. Water vapor is preferably removed in dryers located downstream of compressor 7. Impurity removal, whether carried out in one stage or in more than one stage, is represented by unit 9A representing impurity removal upstream of compressor 7, and by unit 9B representing impurity removal downstream of compressor 7. Unit 9A when present generates stream 10A of removed impurities, and unit 9B when present generates stream 10B of removed impurities.

Compression, cooling and impurity removal, in any sequence, produces feed stream 8 which is fed to VPSA unit 11. Typical characteristics of stream 8 are:
Oxygen content: 10-20 mole %
Carbon dioxide content: 10-50 mole %
Nitrogen content: 50-90 mole %
Hydrogen: zero or trace (<1 ppm)
Carbon monoxide: 0-5 mole %
Water vapor: Dry to saturated at the feed conditions
Pressure: 100-500 psia
Temperature: 80-100° F.

Treatment of stream 8 in VPSA unit, in accordance with the present invention, produces product stream 12 that comprises at least 80 mole % carbon dioxide. Typically the pressure of this stream is 10 to 25 psia.

VPSA unit 11 also produces variable-pressure waste stream 14, which typically contains carbon dioxide, nitrogen, carbon monoxide and hydrogen (if any hydrogen is in the feed and is typically at a pressure that can vary between 500 and 15 psia. Stream 14 can be vented to atmosphere, or subjected to further treatment.

VPSA unit 11 also produces high-pressure waste stream 16, which typically contains carbon dioxide, nitrogen, carbon monoxide and hydrogen (if any hydrogen is in the feed) and is typically at a pressure of 100 to 500 psia. Stream 16, to which stream 10B may be added if desired, is preferably heated such as by passage through heat exchanger 5, and is then more preferably passed through expander 13 (such as a turbine) to generate power that is used to drive compressor 7. Stream 20 emerging from expander 13 can be vented to atmosphere or processed further.

The present invention recognizes that depressurizations of a CO₂-selective adsorbent layer increases the CO₂ concentration in the adsorbent bed(s), even when the feed stream contains no hydrogen. More specifically, the present invention recognizes and utilizes depressurizations of an adsorbent from high pressure (e.g., 100-500 psia) to low pressure(s) (i.e., close to ambient and/or subambient pressures) to increase CO₂ concentration in the bed.

As used herein, a “feed stream” being fed to a CO₂ unit in accordance with the present invention is a stream containing at least carbon dioxide (CO₂) and nitrogen at a pressure between about 100-500 psia (e.g., 375 psia). After the CO₂ concentration is increased by multiple depressurizations, it can be used to produce the CO₂ product by further pressure reduction. For some adsorbents, depressurization from high to low pressure increases CO₂ concentration in the adsorbent bed. This step in the process can be used to eliminate several process steps as described in the prior art. Consequently, several pieces of rotating machinery (e.g., rinse compressor, purge compressor, recycle compressor) and associated power requirements can be eliminated, thus providing a process and system that enhances operation and improves efficiency.

At any time during any of these processes, the beds will be in one of the following categories of steps: feed, depressurization (including a venting step), evacuation, pressure equalizations, and repressurization.

In other alternative embodiments of the present invention, the CO₂ VPSA processes and apparatus can be used to produce CO₂ having a purity of about 80 mole percent from the aforementioned feed gas, employing only one or two depressurizations followed by evacuation and repressurization, without any pressure equalization steps. At any time during any of these processes, the beds will be in one of the following categories of steps: feed, depressurization (including a venting step), evacuation, and repressurization.

In any of the embodiments, each bed is preferably packed with at least two layers of adsorbents. The type and sizing of the adsorbent layer toward the feed end (i.e. a water-selective adsorbent layer) in the bed is selected to remove moisture in the feed stream such that any residual moisture does not deteriorate the performance of the main (i.e., CO₂-selective) adsorbent layer. The water-selective adsorbent layer is also preferably capable of removing impurities (e.g., trace amounts of sulfur or heavy hydrocarbon compounds) from the feed stream, to the extent such impurities are present. The main, second adsorbent layer (i.e., the CO₂-selective adsorbent layer) is used for selectively adsorbing CO₂ from the feed stream after sufficient moisture has been removed.

For the first adsorbent layer (i.e. the water-selective adsorbent layer, adsorbents such as activated alumina, silica gel or zeolite molecular sieve are preferred. These adsorbents are intended to be illustrative and other adsorbents capable of removing sufficient moisture are also suitable for use in accordance with the present invention. Preferred characteristics for such adsorbent(s) include: high crush strength capabilities, high attrition resistance, large bulk density, low inter-particle void, high heat capacity, large thermal conductivity, low-pressure drop and stable in liquid water.

The main layer of adsorbent (i.e., the CO₂-selective adsorbent layer) following the water-selective adsorbent layer preferably has the following characteristics: high selectivity, high working capacity, fast kinetics and low heat of adsorption. Typical examples of such adsorbents include, but are not limited to: are NaY, HY, NaX, silica gel, and activated carbon. Other desired physical properties of the main layer adsorbent (i.e. the CO₂-selective layer) include: high crush strength, high attrition resistance, large bulk density, low inter-particle void, high heat capacity, large thermal conductivity and low-pressure drop during the feed and evacuation steps.

Those skilled in the art will appreciate that a composite mixed layer containing both adsorbents could be used in the present invention so long as the characteristics of the adsorbents are satisfied.

### 6 Bed Cycle

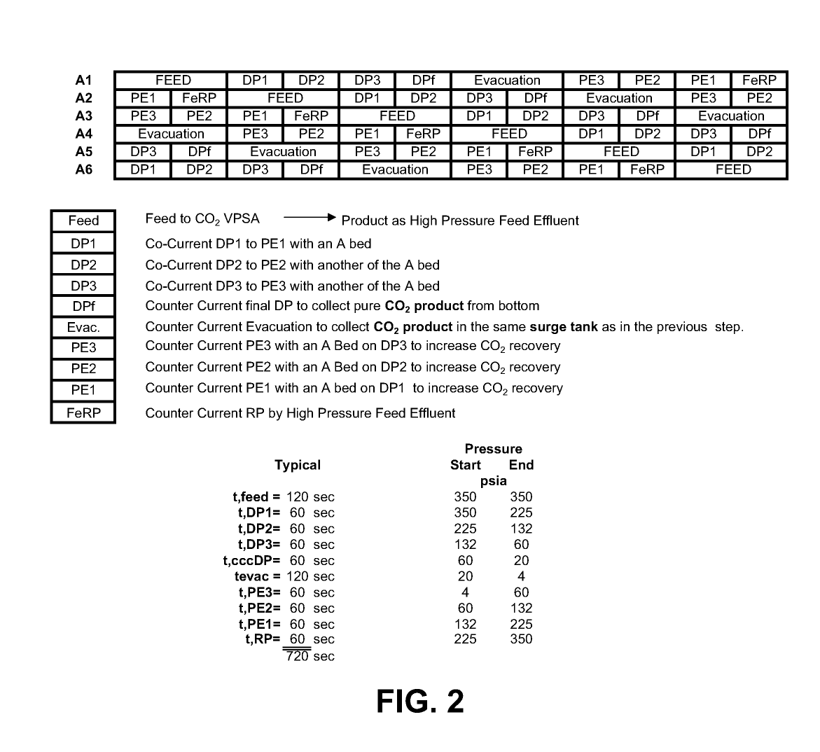

Referring now to FIGS. 2-4, a first embodiment of the present invention having six beds (A1-A6) and using ten steps to produce enriched CO₂ from flue gas is illustrated. The process steps include:

1. Feed Step. A feed stream 8 containing at least carbon dioxide and nitrogen gases and containing trace amounts of hydrogen or no hydrogen, at a high pressure between about 100-500 psia (for example, about 375 psia) is fed to the CO₂ VPSA unit 11 of the present invention. High-pressure feed effluent stream 16 is drawn off from VPSA unit 11. As noted herein, stream 16 can be passed through a turbine in which stream 16 is expanded to produce power that can be used to operate a compressor that compresses the feed. After a predetermined time based upon CO₂ concentration from the VPSA bed, or after CO₂ breakthrough from the bed, this feeding step is terminated.

2. Co-Current (CoC) Depressurization 1 (DP1). The CO₂ VPSA bed, which has finished the feed step is now at high feed pressure (e.g., 100-500 psia), is depressurized to a lower, medium pressure (e.g., 80-400 psia) in a direction the same as (shown in FIG. 2) or opposite to (not shown in FIG. 2) the feed flow.

3. Co-Current (CoC) Depressurization 2 (DP2). The CO₂ VPSA bed, which is now at some medium pressure (e.g., 80-400 psia), is further depressurized to a lower pressure (e.g., 60-300 psia) in a direction the same as (shown in FIG. 2) or opposite to (not shown in FIG. 2) the feed flow.

4. Co-Current (CoC) Depressurization 3 (DP3). The CO₂ VPSA bed, which is now at some medium pressure (e.g., 60-300 psia), is further depressurized to a lower pressure (e.g., 50-200 psia) in a direction the same as (shown in FIG. 2) or opposite to (not shown in FIG. 2) the feed flow.

5. Final Depressurization (DPf). The CO₂ VPSA bed, which is now at a pressure lower than at the start of step 4 (about 50-200 psia) is further depressurized to a pressure close to ambient (about 20 psia) in a direction opposite to (shown in FIG. 2) and/or the same as (not shown in FIG. 2) the feed flow. The stream recovered from this step constitutes a portion of the CO₂ product.

6. Evacuation. The CO₂ VPSA bed, which is now close to ambient pressure (about 20 psia), is evacuated to a predetermined low pressure, a subambient pressure (about 1-12 psia) in a direction opposite to (shown in FIG. 2) or the same as (not shown in FIG. 2) to the feed flow. The stream recovered from this step constitutes another portion, preferably the remaining portion, of the CO₂ product.

7. Countercurrent (CcC) Pressure Equalization 3 (PE3). The evacuated bed is now pressure equalized to a pressure range of the gas produced in step 4 (DP3) (i.e., to about 50-200 psia), preferably employing the gas depressurized in the DP3 step, in a direction the same as (not shown in FIG. 2) or opposite (shown in FIG. 2) to the feed flow. This step increases CO₂ recovery by keeping the CO₂ from step 4 within the VPSA system. This minimizes CO₂ loss by eliminating the need to send the CO₂ to a waste stream.

8. Countercurrent (CcC) Pressure Equalization 2 (PE2). The bed pressure equalized in step 7 is now pressure equalized to a pressure range of the gas produced in step 3 (DP2) (i.e., to about 60-300 psia), preferably employing the gas depressurized in the DP2 step, in a direction the same as (not shown in FIG. 2) or opposite (shown in FIG. 2) to the feed flow. This step increases CO₂ recovery by keeping the CO₂ from step 3 within the VPSA system. This minimizes CO₂ loss by eliminating the need to send the CO₂ to a waste stream.

9. Countercurrent Pressure (CcC) Equalization 1 (PE1). The bed pressure equalized in step 8 is further pressure equalized to a pressure range of the gas produced in step 2 (DP1) (i.e., to about 80-400 psia), preferably employing the gas depressurized in the DP1 step, in a direction the same as (not shown in FIG. 2) or opposite (shown in FIG. 2) to the feed flow. This step further increases CO₂ recovery by keeping the CO₂ from step 2 within the VPSA system. This minimizes CO₂ loss by eliminating the need to send the CO₂ to a waste stream.

10. Repressurization (FeRP). The pressure-equalized bed is repressurized to a feed pressure (100-500 psia) either by the feed gas or by part of the effluent generated from another bed in step 1 (i.e. feed effluent). Following repressurization to feed pressure, this bed is now ready to go back to step 1.

This ten-step process described is for one cycle for one bed in the CO₂ VPSA unit. The above ten steps are carried out in a cyclic manner with the other beds in the unit such that feed-into and feed-effluent from step 1 are continuous. In addition, the evacuation step (number 6) is designed to be continuous. This ensures that the vacuum pump operates continuously, and that there is no break in feed-into the CO₂ VPSA unit or to unit 13 of FIG. 1. Six adsorption beds are utilized in the embodiment described above to maintain the continuity of the key process steps.

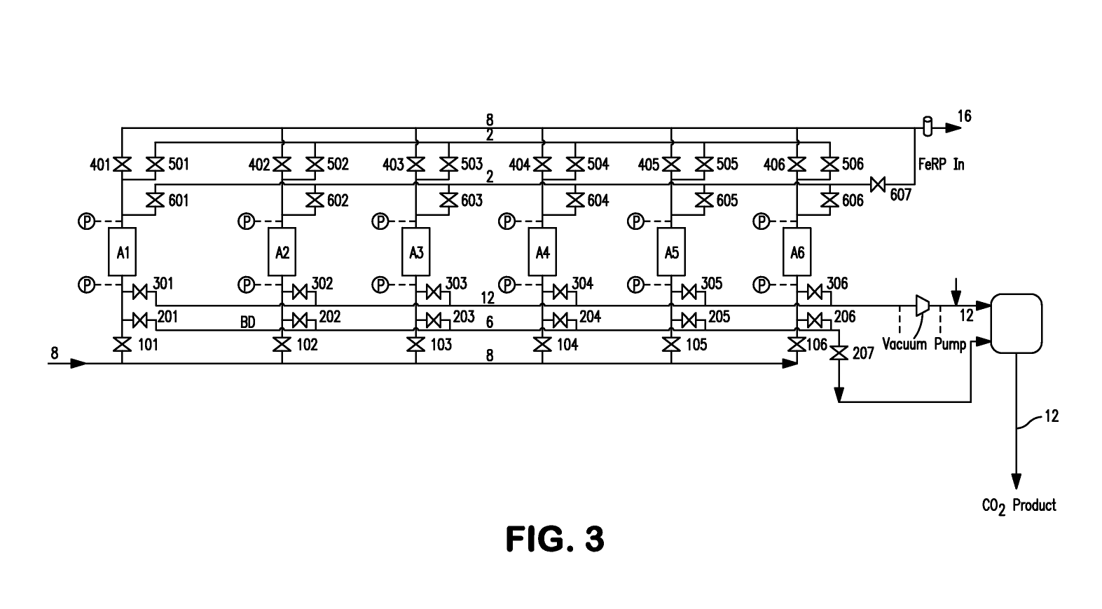

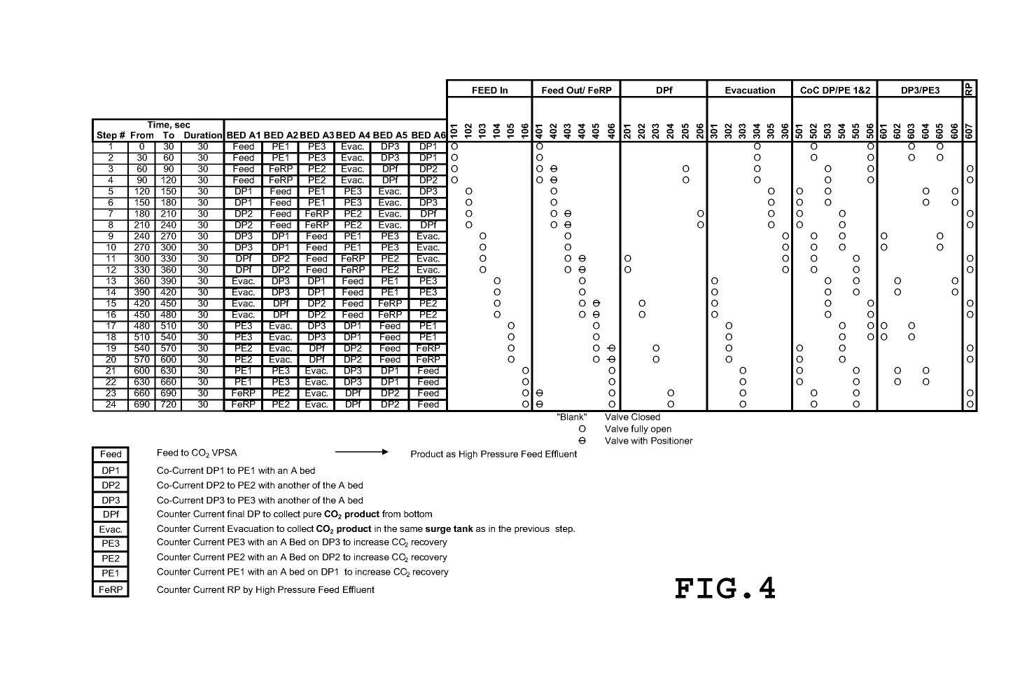

Exemplary corresponding hardware and a flow schematic of the CO₂ VPSA process corresponding to the cycle shown FIG. 2 is depicted in FIG. 3. The various valves in FIG. 3 can be operated in the manner illustrated in FIG. 4 to carry out the ten steps in the six-bed process as described hereinabove. It should be appreciated that pressures and step durations shown are only for illustrative purposes. Those skilled in the art will appreciate that other combinations of pressures and step durations may be used.

As can be appreciated from the above description, the present invention thus relies upon depressurizations of at least one CO₂-selective adsorbent from high pressure to low pressure to increase CO₂ concentration in the bed. After CO₂ concentration is increased, it produces the CO₂ product by further pressure reduction. This became possible based on the discovery that for some adsorbents, pressure reduction from high to low pressure increases CO₂ concentration on the adsorbent.

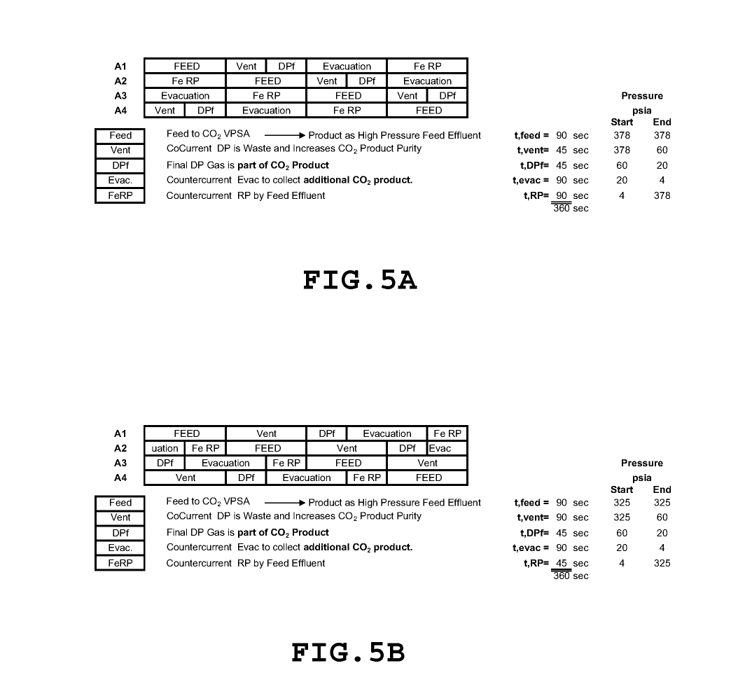

Alternative and additional exemplary embodiments are illustrated in FIGS. 5A and 5B through FIG. 10. These embodiments do not employ pressure equalization.

### 4 Bed Cycle

Referring now to FIGS. 5A through 7B, another embodiment of the present invention has four beds (A1-A4) and uses five steps. The process steps include:

1. Feed Step. A compressed dry flue gas feed stream at a high pressure between about 100-500 psia and purified of impurities is sent to the CO₂ VPSA unit of this embodiment of the present invention. High-pressure feed effluent stream 16 from the CO₂ VPSA unit is preferably sent to a turbine to recover part of the power needed to operate the compressor that compresses the feed stream to its feed pressure. After a predetermined time or after CO₂ breakthrough from the bed on the feed, the feed step is terminated.

2. Co-Current (CoC) Vent. The CO₂ VPSA bed, which has finished the feed step and is now at high feed pressure (e.g., 100-500 psia), is depressurized in a direction the same (shown in FIGS. 5A and 5B) or opposite (not shown in FIG. 5A or 5B) to the feed flow direction. The pressure in the bed at the end of this step is about 50-200 psia and lower than at the end of the feed step.

3. Final Depressurization (DPf). The CO₂ VPSA bed, which is now at the same pressure as at the end of step 2 (about 50-200 psia) is further depressurized to a pressure close to ambient (15-20 psia, preferably about 20 psia) in a direction the same as (not shown in FIG. 5A or 5B) or opposite to (shown in FIGS. 5A and 5B) the feed flow direction. The gas from this step constitutes part of the CO₂ product.

4. Evacuation. The CO₂ VPSA bed, which is now close to ambient pressure (about 20 psia), is evacuated to a predetermined low subatmospheric pressure (about 1-12 psia) in a direction the same as (not shown in FIG. 5A or 5B) or opposite to (shown in FIGS. 5A and 5B) the feed flow direction. The gas from the bed under evacuation constitutes part of the CO₂ product stream.

5. Repressurization (FeRP). The evacuated bed is repressurized to a feed pressure (100-500 psia) either by the feed gas or by part of the effluent (i.e. feed effluent) generated from implementing step 1 on another bed. Following depressurization to feed pressure, this bed is now ready to undergo step 1 again.

The five-step process described above is for one cycle for one bed in the CO₂ VPSA unit. The above five steps are carried out in a cyclic manner with other beds in the unit such that feed-into and feed-effluent from step 1 are continuous. In addition, the evacuation step (step 4) is designed to be continuous. This ensures that the vacuum pump operates continuously, and that there is no break in feed-into the CO₂ VPSA unit or to unit 13. Four adsorption beds are utilized in the embodiment described above to maintain the continuity of the key process steps.

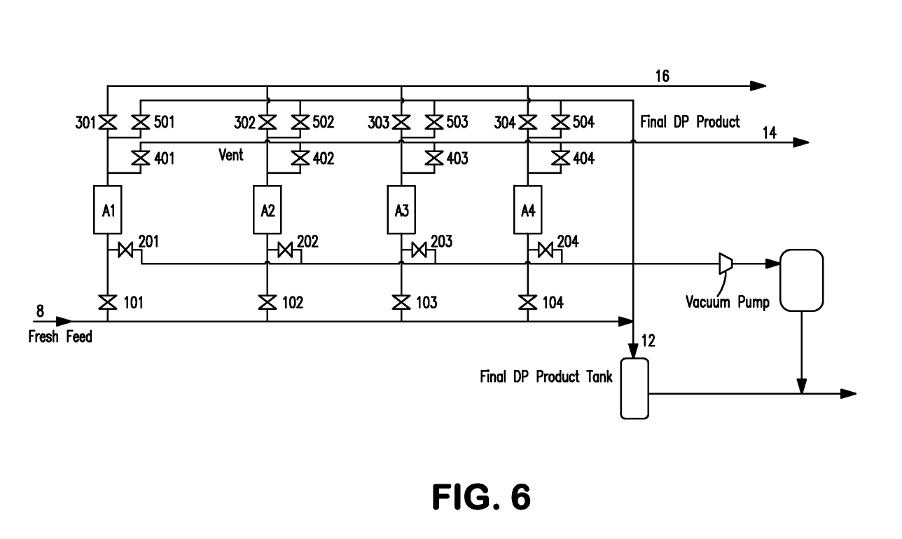

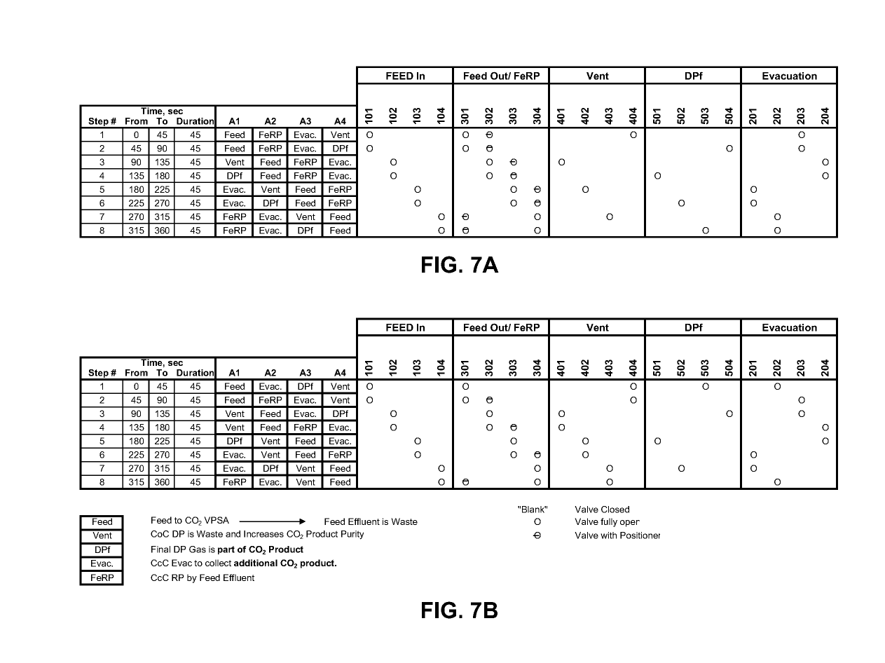

Exemplary corresponding hardware and a flow schematic of the CO₂ VPSA process corresponding to the cycle shown FIGS. 5A and 5B is depicted in FIG. 6. The various valves in FIG. 6 can be operated in the manner illustrated in FIGS. 7A and 7B to carry out the five steps in the four-bed process as described hereinabove.

### 3 Bed Cycle

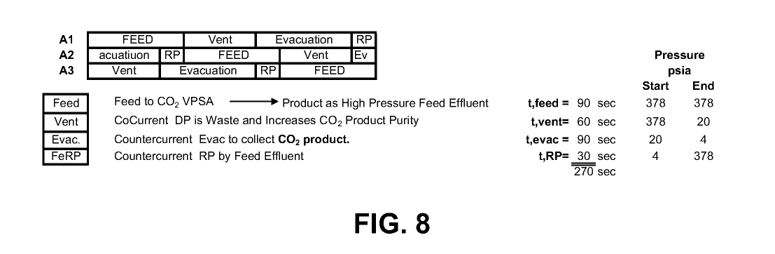

Referring now to FIGS. 8-10, another embodiment of the present invention has three beds (A1-A3) and uses four steps to produce enriched CO₂ from flue gas is illustrated. The process steps include:

1. Feed Step. A compressed dry flue gas feed stream at a high pressure between about 100-500 psia and purified of impurities is sent to the CO₂ VPSA unit of this embodiment of the present invention. High-pressure feed effluent stream 16 from the CO₂ VPSA unit is preferably sent to a turbine to recover part of the power needed to operate the compressor that compresses the feed stream to its feed pressure. After a predetermined time or after CO₂ breakthrough from the bed on the feed, the feed step is terminated.

2. Co-Current (CoC) Vent. The CO₂ VPSA bed, which has finished the feed step, is now at high feed pressure (e.g., 100-500 psia), is depressurized in a direction the same (shown in FIG. 8) or opposite (not shown in FIG. 8) to the feed flow direction. The pressure in the bed at the end of this step is close to ambient (15-20 psia, preferably about 20 psia).

3. Evacuation. The CO₂ VPSA bed, which is now close to ambient pressure (about 20 psia), is evacuated to a predetermined low pressure, to a sub-ambient pressure (about 1-12 psia) in a direction the same as (not shown in FIG. 8) or opposite to (shown in FIG. 8) the feed flow direction. The gas from the bed under evacuation constitutes the CO₂ product.

4. Repressurization (FeRP). The evacuated bed is repressurized to a feed pressure (100-500 psia) either by the feed gas or by part of the effluent (i.e. feed effluent) generated from implementing step 1 on another bed. Following depressurization to feed pressure, this bed is now ready to undergo step 1 again.

The four-step process described above is for one cycle for one bed in the CO₂ VPSA unit. The above four steps are carried out in a cyclic manner with the other beds in the unit such that feed-into and feed-effluent from step 1 are continuous. In addition, the evacuation step (step 3) is designed to be continuous. This ensures that the vacuum pump operates continuously, and that there is no break in feed-into the CO₂ VPSA unit or unit 13. Three adsorption beds are utilized in the embodiment described above to maintain the continuity of the key process steps.

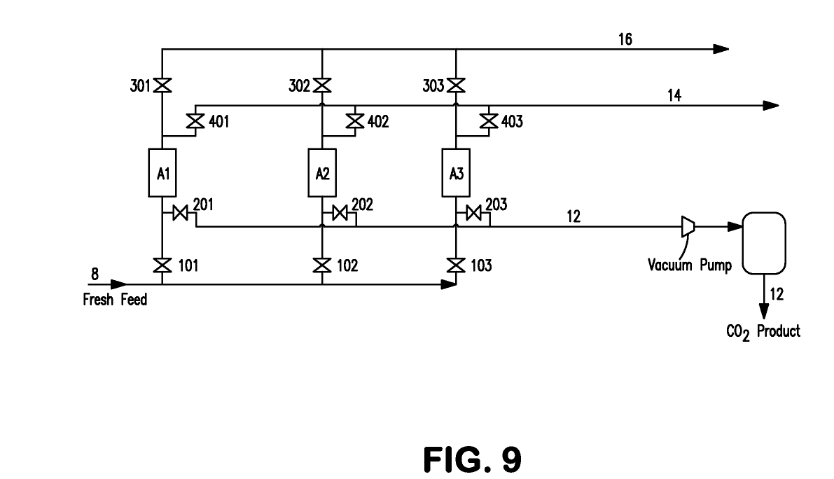

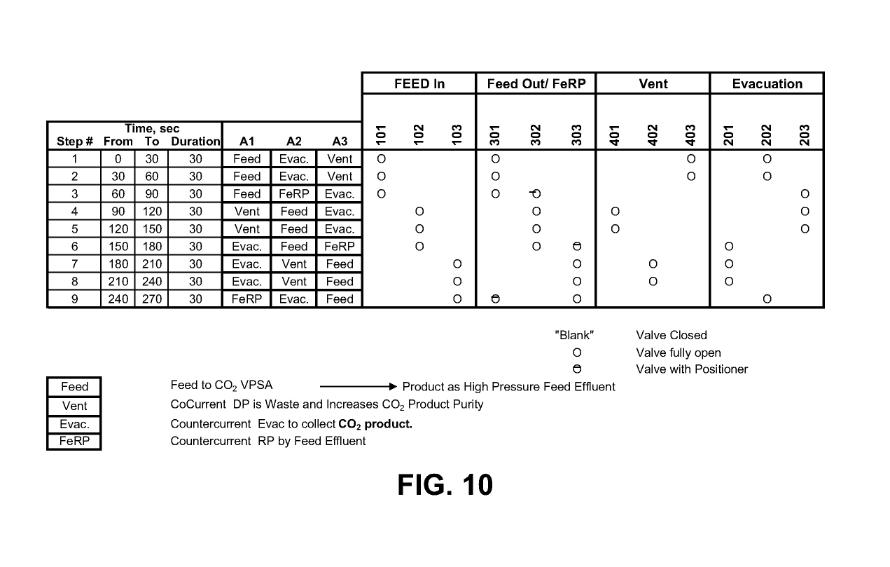

Exemplary corresponding hardware and a flow schematic of the CO₂ VPSA process corresponding to the cycle shown FIG. 8 is depicted in FIG. 9. The various valves in FIG. 9 can be operated in the manner illustrated in FIG. 10 to carry out the four steps in the three-bed process as described hereinabove.

In alternative embodiments of the present invention, storage tanks may be added in place of some of the adsorbent beds in the process cycle to store some of the intermediate gas streams such as the depressurized gas. The purpose of these storage tanks is to maintain flow into and out of the CO₂ VPSA unit as continuous.

The present invention thus provides processes and apparatus for the recovery of medium purity (e.g., approximately ≧80 mole %) carbon dioxide from flue gas. In accordance with preferred embodiments of the present invention, there is constant feed, constant product being produced and rotating machinery is preferably run continuously so as to eliminate unnecessary tank(s). If, however, there are reasons for limiting the number of adsorbent beds (e.g. high cost of the adsorbent) storage tanks instead of the adsorbent vessels may be used as explained above. While every bed the same cycle, the number of beds is to be minimized taking these factors into consideration.

What is claimed is:

1. A vacuum pressure swing adsorption (VPSA) process for the recovery of carbon dioxide from a multi-component gas mixture which contains at least carbon dioxide and nitrogen and contains no hydrogen or no more than a trace amount of hydrogen, and which is at a pressure in a first superatmospheric pressure range, in a VPSA unit containing at least one adsorption bed containing at least one CO₂-selective adsorbent, the process comprising:
feeding said multi-component gas mixture to the at least one adsorption bed at a first pressure within said first superatmospheric pressure range for a predetermined time to adsorb carbon dioxide onto said adsorbent;
depressurizing the at least one adsorption bed in a first depressurization step from the first pressure to a second pressure that is lower than said first pressure and is within a second pressure range, in a same direction as or an opposite direction to the feed flow;
depressurizing the at least one adsorption bed in a second depressurization step from the second pressure to a third pressure that is lower than said second pressure and is within a third pressure range, in a same direction as or an opposite direction to the feed flow;
depressurizing the at least one adsorption bed in a third depressurization step from the third pressure to a fourth pressure that is lower than said third pressure and is within a fourth pressure range, in a same direction as or an opposite direction to the feed flow;
depressurizing the at least one adsorption bed in a final depressurization step from the fourth pressure to a pressure that is within a range close to ambient in a same direction as the feed flow or in a direction opposite to the feed flow to produce at least a first portion of CO₂ product;
evacuating the at least one adsorption bed from the pressure that is within a range close to ambient to a pressure below ambient in a same direction as the feed flow or in a direction opposite to the feed flow to produce at least a second portion of CO₂ product;
pressure equalizing the at least one adsorption bed in a first pressure equalization step in a same direction as the feed flow or in a direction opposite to the feed flow;
further pressure equalizing the at least one adsorption bed in a second pressure equalization step in a same direction as the feed flow or in a direction opposite to the feed flow;
further pressure equalizing the at least one adsorption bed in a third pressure equalization step in a same direction as the feed flow or in a direction opposite to the feed flow; and
repressurizing the at least one adsorption bed in a repressurization step to a pressure in the first pressure range;
wherein the process is repeated cyclically.

2. The process of claim 1, carried out in a VPSA unit comprising six adsorption beds.

3. A process for the recovery of carbon dioxide, comprising compressing a multi-component gas mixture which contains at least carbon dioxide and nitrogen and contains no hydrogen or no more than a trace amount of hydrogen, to a pressure in a first superatmospheric pressure range, and recovering carbon dioxide from said compressed mixture in a VPSA unit by a process according to claim 1, wherein an effluent gas stream is recovered from said VPSA unit and is expanded to provide power that is used in compressing said multi-component gas mixture.

4. The process of claim 1, wherein said first superatmospheric pressure range is between about 100-500 psia.

5. The process of claim 1, wherein the second pressure range in said first depressurization step is between about 80-400 psia.

6. The process of claim 1, wherein the third pressure range in said second depressurization step is between about 60-300 psia.

7. The process of claim 1, wherein the fourth pressure range in said third depressurization step is between about 50-200 psia.

8. The process of claim 1, wherein the first depressurization step is in a direction the same as the direction of the feed flow.

9. The process of claim 1, wherein the second depressurization step is in a direction the same as the direction of the feed flow.

10. The process of claim 1, wherein the third depressurization step is in a direction the same as the direction of the feed flow.

11. The process of claim 1, wherein the fourth depressurization step is in an opposite direction as the direction of the feed flow.

12. The process of claim 1, wherein the pressure range close to ambient in said final depressurizaton step is 15-20 psia.

13. The process of claim 1, wherein the pressure below ambient in said evacuating step is 1-12 psia.

14. The process of claim 1, wherein the at least first and at least second portions of the CO₂ product are combined to form a final CO₂ product.

15. The process of claim 1, wherein the CO₂-selective adsorbent is selected from the group comprising: NaY, HY, NaX, silica gel, activated carbon and combinations thereof.

16. A vacuum pressure swing adsorption (VPSA) process for the recovery of carbon dioxide from a multi-component gas mixture which contains at least carbon dioxide and nitrogen and contains no hydrogen or no more than a trace amount of hydrogen, and which is at a pressure in a first superatmospheric pressure range, in a VPSA unit containing at least one adsorption bed containing at least one CO₂-selective adsorbent, the process comprising:
feeding said multi-component gas mixture to the at least one adsorption bed at a first pressure within said first superatmospheric pressure range for a predetermined time to adsorb carbon dioxide onto said adsorbent;
venting the at least one adsorption bed in a first depressurization step from the first pressure to a second pressure that is lower than said first pressure and is within a second pressure range, in a same direction as or an opposite direction to the feed flow, to produce a vent stream that can be released into the atmosphere;
depressurizing the at least one adsorption bed in a final depressurization step from the second pressure to a pressure that is within a range close to ambient in a same direction as the feed flow or in a direction opposite to the feed flow to produce at least a first portion of CO₂ product;
evacuating the at least one adsorption bed from the pressure that is within a range close to ambient to a pressure below ambient in a same direction as the feed flow or in a direction opposite to the feed flow to produce at least a second portion of CO₂ product; and
repressurizing the at least one adsorption bed in a repressurization step to a pressure in the first pressure range;
wherein the process is repeated cyclically.

17. The process of claim 16, carried out in a VPSA unit comprising four adsorption beds.

18. A process for the recovery of carbon dioxide, comprising compressing a multi-component gas mixture which contains at least carbon dioxide and nitrogen and contains no hydrogen or no more than a trace amount of hydrogen, to a pressure in a first superatmospheric pressure range, and recovering carbon dioxide from said compressed mixture in a VPSA unit by a process according to claim 16, wherein an effluent gas stream is recovered from said VPSA unit and is expanded to provide power that is used in compressing said multi-component gas mixture.

19. The process of claim 16, wherein said first superatmospheric pressure range is between about 100-500 psia.

20. The process of claim 16, wherein the second pressure range in said first depressurization step is between about 80-400 psia.

21. The process of claim 16, wherein the pressure range close to ambient in said final depressurization step is 15-20 psia.

22. The process of claim 16, wherein the pressure below ambient in said evacuating step is 1-12 psia.

23. The process of claim 16, wherein the at least first and at least second portions of the CO₂ product are combined to form a final CO₂ product.

24. The process of claim 16, wherein the CO₂-selective adsorbent is selected from the group comprising: NaY, HY, NaX, silica gel, activated carbon and combinations thereof.

25. A vacuum pressure swing adsorption (VPSA) process for the recovery of carbon dioxide from a multi-component gas mixture which contains at least carbon dioxide and nitrogen and contains no hydrogen or no more than a trace amount of hydrogen, and which is at a pressure in a first superatmospheric pressure range, in a VPSA unit containing at least one adsorption bed containing at least one CO₂-selective adsorbent, the process comprising:
feeding said multi-component gas mixture to the at least one adsorption bed at a first pressure within said first superatmospheric pressure range for a predetermined time to adsorb carbon dioxide onto said adsorbent;
depressurizing the at least one adsorption bed from the first pressure to a pressure that is within a range close to ambient in a same direction as the feed flow or in a direction opposite to the feed flow to produce a vent stream that can be released into the atmosphere;
evacuating the at least one adsorption bed from the pressure that is within a range close to ambient to a pressure below ambient in a same direction as the feed flow or in a direction opposite to the feed flow to produce a CO₂ product; and
repressurizing the at least one adsorption bed in a repressurization step to a pressure in the first pressure range;
wherein the process is repeated cyclically.

26. The process of claim 25, carried out in a VPSA unit comprising three adsorption beds.

27. A process for the recovery of carbon dioxide, comprising compressing a multi-component gas mixture which contains at least carbon dioxide and nitrogen and contains no hydrogen or no more than a trace amount of hydrogen, to a pressure in a first superatmospheric pressure range, and recovering carbon dioxide from said compressed mixture in a VPSA unit by a process according to claim 25, wherein an effluent gas stream is recovered from said VPSA unit and is expanded to provide power that is used in compressing said multi-component gas mixture.

28. The process of claim 25, wherein said first superatmospheric pressure range is between about 100-500 psia.

29. The process of claim 25, wherein the pressure range close to ambient in said depressurization step is 15-20 psia.

30. The process of claim 25, wherein the pressure below ambient in said evacuating step is about 1-12 psia.

31. The process of claim 25, wherein the CO₂-selective adsorbent is selected from the group comprising: NaY, HY, NaX, silica gel, activated carbon and combinations thereof.
